(19) United States
(12) Patent Application Publication
(10) Pub. No.: US 2011/0249779 A1
(43) Pub. Date: Oct. 13, 2011

(54) NOISE VARIANCE ESTIMATION FOR DIVERSITY RECEPTION

(75) Inventors: Honglei Miao, Espoo (FI); Risto Juhani Paatelma, Oulu (FI)

(73) Assignee: NOKIA CORPORATION, Espoo (FI)

(21) Appl. No.: 13/140,004

(22) PCT Filed: Dec. 18, 2009
(86) PCT No.: PCT/FI2009/051014

§ 371 Date: Jun. 15, 2011

Related U.S. Application Data
(60) Provisional application No. 61/203,406, filed on Dec. 22, 2008.

(51) Int. Cl. H04B 7/10

(52) U.S. Cl. 375/347

(57) ABSTRACT

A first noise variance is determined for a signal received on a first diversity branch of a receiver, and a second noise variance is determined for a signal received on a second diversity branch of the receiver. The signal received on the second diversity branch is scaled as a function of a ratio of the first noise variance and the second noise variance. A received signal is then estimated by combining the signal on the first diversity branch with the scaled signal on the second diversity branch. In this manner reasonable complexity is used to process diversity signals that exploits the difference in noise variation at the different receive diversity branches, without requiring matrix inversion and without having to assume the same noise variation across the diversity receive branches. Methods, apparatuses and computer programs are detailed operable in HSDPA and other systems.

### TECHNICAL FIELD

The exemplary and non-limiting embodiments of this invention relate generally to wireless communication systems, methods, devices and computer programs and, more specifically, relate to processing a receive-diversity signal.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In at least the high speed downlink packet access (HSDPA) system, the receiver which employs the equalizer and receiver diversity is termed a type 3 receiver according to the defining specifications (e.g., 3GPP TS25.101, “User equipment (UE) radio transmission and reception (FDD) (release 8)”, V8.2.0 2008-03).

Extensive studies have been done on the HSDPA equalizer technique with receiver diversity. Typically, the linear minimum mean squared error (LMMSE) based equalizer, which jointly utilizes the received signals from two receiver branches, is considered for such a type 3 receiver. The complexity of the MMSE equalizer may be high (mainly such high complexity could be due to the required matrix inversion). For example, a paper by Jianzhong Zhang, Tejas Bhatt and Giridhar Mandyam, entitled “Efficient linear equalization for high data rate downlink CDMA signalling” (proceeding of IEEE 37^{th} Asilomar conference 2003, vol. 1, pp 141-145) describes a fast Fourier transform (FFT) based MMSE approximation equalization method where the matrix inversion is avoided. The FFT based MMSE equalizer can be straightforwardly extended to the receive diversity case given the assumption that the noise variances at two receive branches are equal. However, due to the fact that two receive antennas located in the UE are independently separated, in addition to different propagation channels, the geometry values, or signal to noise ratios, associated with two receive branches can also be very different.

What is needed in the art is a receiver and method for receiving diversity signals that has reasonable computational complexity and that exploits the difference in noise variation at the different receive diversity branches. For example, it would be advantageous to have a receiver that does not require correlation matrix inversion. As another example, it would be advantageous to have a receiver that does not assume, when processing a received signal on two or more receive branches, that noise variation across the diversity receive branches is always the same regardless of actual noise conditions.

### SUMMARY

In accordance with a first exemplary aspect of the invention there is a method comprising: determining a first noise variance for a signal received on a first diversity branch; determining by the apparatus a second noise variance for a signal received on a second diversity branch; scaling the signal received on the second diversity branch as a function of a ratio of the first noise variance and the second noise variance; and estimating a received signal by combining the signal on the first diversity branch with the scaled signal on the second diversity branch.

In accordance with a second exemplary aspect of the invention there is a memory storing a program of computer readable instructions that when executed by at least one processor result in actions. In this second aspect the actions comprise: determining a first noise variance for a signal received on a first diversity branch of a receiver; determining a second noise variance for a signal received on a second diversity branch of the receiver; scaling the signal received on the second diversity branch as a function of a ratio of the first noise variance and the second noise variance; and estimating a received signal by combining the signal on the first diversity branch with the scaled signal on the second diversity branch.

In accordance with a third exemplary aspect of the invention there is an apparatus comprising a memory storing a program of computer readable instructions; and at least one processor. The at least one processor is configured, with the memory, to: determine a first noise variance for a signal received on a first diversity branch of the apparatus; determine a second noise variance for a signal received on a second diversity branch of the apparatus; scale the signal received on the second diversity branch as a function of a ratio of the first noise variance and the second noise variance; and estimate a received signal by combining the signal on the first diversity branch with the scaled signal on the second diversity branch.

In accordance with a fourth exemplary aspect of the invention there is an apparatus comprising first determining means; second determining means; scaling means; and estimating means. The first determining means is for determining noise variance for a signal on a first diversity branch of a receiver. The second determining means is for determining noise variance for a signal on a second diversity branch of the receiver. The scaling means is for scaling the signal on the second diversity branch as a function of a ratio of the first noise variance and the second noise variance. And the estimating means is for estimating a received signal by combining the signal on the first diversity branch with the scaled signal on the second diversity branch.

### BRIEF DESCRIPTION OF THE DRAWINGS

FIG. 1 is a schematic block diagram of a Type 3 receiver using noise variance and pilot Ec/Ior estimation according to an exemplary embodiment of the invention.

FIG. 2A shows a simplified block diagram of various electronic devices (such as for example the receiver of FIG. 1) that are suitable for use in practicing the exemplary embodiments of this invention.

FIG. 2B shows a more particularized block diagram of a user equipment such as that shown at FIG. 2A.

FIG. 3 is a graph of throughput of the HSDPA receiver with receive diversity comparing an exemplary embodiment of the invention against a legacy solution which assumes the same noise variance at both receive branches, where gain on the first branch is 10 dB and gain on the second branch is 1 dB.

FIG. 4 is similar to FIG. 3 but where gain on the second branch is 7 dB.

FIG. 5 is similar to FIG. 3 but where gain on both the first and second branches is 10 dB.

FIG. 6 is a logic flow diagram that illustrates the operation of a method, and a result of execution of computer program instructions embodied on a computer readable memory, in accordance with an exemplary embodiment of this invention.

### DETAILED DESCRIPTION

Following is described a process (e.g., method, algorithm) for noise variance estimation, which are the necessary information for the design of the LMMSE equalizer. Such an equalizer may be employed in a particular embodiment within a HSDPA receiver with two receive branches. While such a use is the context of the description below, the HSDPA receiver is not a limitation to these teachings; they may be employed in any diversity receiver such as may be operating in a UTRAN (universal mobile telecommunications terrestrial radio access network) system, or an E-UTRAN (evolved UTRAN) system, or a WLAN (wireless local area network) system, or a WCDMA (wireless code division multiple access) system, a cognitive radio system, and the like. Additionally, it will be apparent these teaching may be employed in any receiver operating in a multiple-input and multiple-output system.

Notations used below are conventional, as follows. Upper- and lowercase boldface letters denote matrices and vectors, respectively. (.)^{T} denotes the transpose; (.)^{H} denotes the Hermitian transpose; and (.)* defines the complex conjugate operation. Matrix Iₙ stands for the identity matrix of order n. E(a·b*) denotes the correlation coefficient between two random variables. A carat over a matrix or vector) (\hat{·}) indicates it is an estimate.

As noted above, the type 3 HSDPA receiver typically applies the LMMSE method for the equalizer. Let F and L define the equalizer filter length and the channel impulse response length in samples, respectively. The received signal model sampled at two times the chip rate from two receive antennas can be described as

$$r [ n ] = Hs [ n ] + η [ n ] , \\ r [ n ] = ( \begin{matrix}{r}_{1} [ n ] \\ {r}_{2} [ n ]\end{matrix} ) , \\ H = ( \begin{matrix}{H}_{1} \\ {H}_{2}\end{matrix} ) , \\ η ⌈ n ⌉ = ( \begin{matrix}{η}_{1} [ n ] \\ {η}_{n} [ n ]\end{matrix} ) , \qquad [ 1 ]$$

Terms from equation [1] are defined as follows.

$$s [ n ] = {( s [ n ] , s [ n - 1 ] , ⋯ s [ n - \frac{F + L}{2} + 2 ] )}^{T} ∈ {C}^{\frac{F + L}{2} - 1}$$

denotes the chip vector consisting of the n th and

$$\frac{F + L}{2} - 2$$

onwards transmitted chips.
rᵢ[n]=(rᵢ[2n+1], rᵢ[2n], . . . rᵢ[2n−F+2])^{T} εC^{F} defines the received signal vector of the i th receive branch consisting of successive F samples which depend on the n th and onwards transmitted chips.
Hᵢ defines the channel matrix with respect to the i th receive antenna. It is constructed from the baseband equivalent channel impulse response (CIR) hᵢ=(h_{i,0}, . . . , h_{i,L-1})^{T}εC^{L} as follows

$${H}_{i} = ( \begin{matrix}{h}_{i , 1} & {h}_{i , 3} & ⋯ & {h}_{i , L - 1} & 0 & ⋯ & 0 & 0 & ⋯ & ⋯ & 0 \\ {h}_{i , 0} & {h}_{i , 2} & ⋯ & {h}_{i , L - 2} & 0 & ⋯ & 0 & ⋯ & ⋯ & ⋯ & 0 \\ 0 & {h}_{i , 1} & {h}_{i , 3} & ⋯ & {h}_{i , L - 1} & 0 & ⋮ & ⋮ & ⋮ & ⋯ & 0 \\ 0 & {h}_{i , 0} & {h}_{i , 2} & ⋯ & {h}_{i , L - 2} & 0 & ⋮ & 0 & ⋮ & ⋯ & 0 \\ ⋮ & ⋱ & ⋱ & ⋱ & ⋱ & ⋱ & ⋮ & ⋮ & ⋮ & ⋯ & 0 \\ 0 & ⋯ & 0 & ⋱ & ⋱ & ⋱ & ⋱ & ⋱ & ⋯ & ⋯ & 0 \\ 0 & ⋯ & 0 & ⋱ & ⋱ & ⋱ & ⋱ & ⋱ & ⋱ & ⋯ & 0 \\ 0 & ⋯ & 0 & ⋯ & ⋯ & ⋯ & 0 & {h}_{i , 1} & {h}_{i , 3} & ⋯ & {h}_{i , L - 1} \\ 0 & ⋯ & 0 & ⋯ & ⋯ & ⋯ & 0 & {h}_{i , 0} & {h}_{i , 2} & ⋯ & {h}_{i , L - 2}\end{matrix} ) ∈ {C}^{F \times ( \frac{F + L}{2} - 1 )} \qquad [ 2 ]$$

ηᵢ[n]=(ηᵢ[2n+1], ηᵢ[2n], . . . ηᵢ[2n−F+2])^{T}εC^{F} defines the noise signal vector in the received signal at the i th receive antenna.
ηᵢ[n]˜CN(0_{F},σ_{η}_{ᵢ}²I_{F}). According to the MMSE criteria (see for example, S. M. Kay, “Fundaments of statistical signal processing: estimation theory”, Prentice Hall, 1993, pages 344-347), the LMMSE based estimate for the D th delayed transmitted composite chip s[n−D] in s[n] is expressed as

$$\begin{matrix}\hat{s} [ n - D ] = {w}_{LMMSE}^{H} \cdot r [ n ] , & [ 3 ] \\ {w}_{LMMSE} = {( {HH}^{H} + ( \begin{matrix}{σ}_{{η}_{1}}^{2} {I}_{F} & 0 \\ 0 & {σ}_{{η}_{2}}^{2} {I}_{F}\end{matrix} ) )}^{- 1} H {δ}_{D} , & \end{matrix}$$

where δ_{D} stands for the unit vector whose the D+1th element is 1, and other elements are all zeros.

As shown at equation [3], the LMMSE estimates needs the information about the channel impulse responses (CIRs) and noise variances with respect to two receive antennas. Conventional approaches to processing diversity signals on different branches assumes that the noise variance on both branches is equal (in a HSDPA type 3 receiver, this is reflected as assuming the common pilot channel (CPICH) power is one).

As a result, the estimated CIR is a scaled version of the true CIR, i.e., ĥᵢ=\sqrt{γ_{P}}hᵢ+n_{CIR}, therefore the LMMSE solution shown at equation [3] using the CIR estimates becomes

$${w}_{LMMSE} = {( \frac{1}{{γ}_{P}} \hat{H} {\hat{H}}^{H} + ( \begin{matrix}{σ}_{{η}_{1}}^{2} {I}_{F} & 0 \\ 0 & {σ}_{{η}_{2}}^{2} {I}_{F}\end{matrix} ) )}^{- 1} \hat{H} {δ}_{D} . \qquad [ 4 ]$$

As shown at equation [4], in addition to the CIR estimate ĥ, the LMMSE solution for the type 3 receiver also needs the noise variance estimates and pilot power to transmitted signal power ratio Ec/Ior (γ_{P}) estimate.

Most of the current type 3 receiver algorithms typically assume that both receivers have the same noise variance, for example, σₙ_{₁}²=σₙ_{₂}²=τₙ². This assumption can hold in certain instances, such as in general when the channel is an ergodic process and fast fading. Due to this assumption the solution at equation [4] would become:

$$\begin{matrix}{w}_{LMMSE} = {( \frac{1}{{γ}_{P}} \hat{H} {\hat{H}}^{H} + {σ}_{η}^{2} {I}_{2 F} )}^{- 1} \hat{H} {δ}_{D} ∝ \\ {( \hat{H} {\hat{H}}^{H} + {γ}_{P} {σ}_{η}^{2} {I}_{2 F} )}^{- 1} \hat{H} {δ}_{D} \\ {=}^{κ = {γ}_{P} {σ}_{η}^{2}} {( \hat{H} {\hat{H}}^{H} + κ \cdot {I}_{2 F} )}^{- 1} \hat{H} {δ}_{D}\end{matrix} \qquad [ 5 ]$$

As shown at equation [5], it is not necessary to explicitly estimate the pilot Ec/Ior and noise variance for the LMMSE solution. Instead, a single diagonal loading factor κ needs to be determined. Ideally, κ can be obtained by calculating the product of γ_{P} and σ_{η}². In practice, some suboptimal solutions are usually utilized to provide κ. For instance, the signal to noise ratio (SNR) for the CPICH is measured at the output of the equalizer or the de-spreader, which is then used to adjust the diagonal loading factor to maximize the SNR of the signal being measured.

To further reduce the complexity of matrix inversion (2F×2F) required by equation [5], by virtue of the matrix-inversion lemma (see for example G. H. Golub and C. V. Loan, “Matrix Computation”, 3^{rd} ed. Johns Hopkins University Press, 1996, page 50), equation [5] can be formulated as:

$$\begin{matrix}{w}_{LMMSE} = {( \hat{H} {\hat{H}}^{H} + κ \cdot {I}_{2 F} )}^{- 1} \hat{H} {δ}_{D} \\ = {\hat{H} ( {\hat{H}}^{H} \hat{H} + κ \cdot {I}_{\frac{F + L}{2} - 1} )}^{- 1} {δ}_{D} \\ = {\hat{H} ( {\hat{H}}_{1}^{H} {\hat{H}}_{1} + {\hat{H}}_{2}^{H} {\hat{H}}_{2} + κ \cdot {I}_{\frac{F + L}{2} - 1} )}^{- 1} {δ}_{D}\end{matrix} \qquad [ 6 ]$$

The equalizer taps for two receive branches can be further obtained from equation [6] as

$${w}_{1 , LMMSE} = {{\hat{H}}_{1} ( {\hat{H}}_{1}^{H} {\hat{H}}_{1} + {\hat{H}}_{2}^{H} {\hat{H}}_{2} + κ \cdot {I}_{\frac{F + L}{2} - 1} )}^{- 1} {δ}_{D} \\ {w}_{2 , LMMSE} = {{\hat{H}}_{2} ( {\hat{H}}_{1}^{H} {\hat{H}}_{1} + {\hat{H}}_{2}^{H} {\hat{H}}_{2} + κ \cdot {I}_{\frac{F + L}{2} - 1} )}^{- 1} {δ}_{D} \qquad [ 7 ]$$

Then the estimate of the composite chip s[n−D] in equation [3] above can be expressed as follows:

ŝ[n−D]=w_{1,LMMSE}^{H}·r₁[n]+w_{2,LMMSE}^{H}·r₂[n] [8]

In addition to the dimension reduction of the matrix inversion in equation [7], for example, from a size (2F×2F) matrix to a size

$$( ( \frac{F + L}{2} - 1 ) \times ( \frac{F + L}{2} - 1 ) )$$

the matrix,

$$( {\hat{H}}_{1}^{H} {\hat{H}}_{1} + {\hat{H}}_{2}^{H} {\hat{H}}_{2} + κ \cdot {I}_{\frac{F + L}{2} - 1} )$$

demonstrates a Toeplitz structure, so that the FFT based algorithm in the paper cited in background above by Jianzhong Zhang, Tejas Bhatt and Giridhar Mandyam can be directly applied in the receiver diversity case as well.

The preceding development of the solution shown in equations [5] through [8] is based on the assumption that two receive branches have the same noise variance. However, due to a slow moving channel and independent radio frequency (RF) receiver branches, it has been observed in practical wireless systems that the noise variances at two baseband receivers may not be equal in general, and sometimes they can have a few dB differences so that the solution shown in equation [7] may not exhibit a good performance.

Next, exemplary embodiments of an LMMSE solution which accommodates for different noise variances are described. The exemplary embodiments presented herein estimate the noise variances for two receive branches. As will be shown, the LMMSE solution of those exemplary and non-limiting embodiments have similar complexity as equation [7] by virtue of the estimated noise variances. More specifically, exemplary embodiments presented herein estimate the noise variance σ_{η}_{ᵢ}² and pilot power to total transmitted signal power ratio (Ec/Ior, designated as γ_{P}), which are then used for example in the HSDPA type 3 receiver. Additionally, detailed below is an exemplary embodiment that uses a conversion of equation [4] above to a form so that the FFT based method (such as for example that detailed in the paper noted in background by Jianzhong Zhang, Tejas Bhatt and Giridhar Mandyam) can also be applied in this general receive diversity scenario.

Exemplary embodiments of this invention utilize the autocorrelation and cross-correlation coefficients of the received signals from two receive branches, and the channel impulse response (CIR) estimates ĥ from the CPICH channel to estimate the noise variances σ_{η}_{ᵢ}² of two receive branches and pilot power to the total transmitted signal power ratio (Ec/Ior, γ_{P}). The CIR is estimated by correlating the received signal with the training sequence transmitted in the common pilot channel (e.g., CPICH in HSDPA). We assume the CPICH has a nominal power (one), then correlate the received signal with the CPICH of different delays in terms of different samples of the received signal in order to estimate the channel coefficients (taps) corresponding to the different multipaths in the resolution of samples. It is noted that more than two diversity receive branches may be used but only two are assumed for this detailed explanation. In the following, C_{i,j},i,j=1,2 defines the correlation coefficients between the baseband received signals at the i^{th} and j^{th} receive branches. Specifically, C₁₁ and C₂₂ refer to the autocorrelation coefficients of the received signal at the 1^{st} and 2^{nd} receive branches, respectively; and C₁₂ defines the cross-correlation coefficient between the received signals at those two branches. Single numerical subscripts refer to a particular (first, second) receive branch.

While the examples detailed below are in the context of two receive diversity branches (e.g., two receive antennas), this is not a limit to these teachings as noted above. A receiver according to these teachings may have two or three or more diversity branches, and the pair-wise diversity processing may be done on any pair or on multiple pairs of those receive diversity branches. For example, a receiver with three diversity branches may process according to the below examples on branch 1 and 2, and also on branch 2 and 3, and then process the two results as another pair of diversity branches for combining and eventual output as the estimate of the received signal.

The three correlation coefficients for the two branches are calculated as follows

$${C}_{11} = E ( {r}_{1} [ 2 n ] {r}_{1}^{*} [ 2 n ] ) + E ( {r}_{1} [ 2 n + 1 ] {r}_{1}^{*} [ 2 n + 1 ] ) = \frac{1}{{γ}_{p}} {\hat{h}}_{1}^{H} {\hat{h}}_{1} + 2 {σ}_{{η}_{1}}^{1} \\ {C}_{22} = E ( {r}_{2} [ 2 n ] {r}_{2}^{*} [ 2 n ] ) + E ( {r}_{2} [ 2 n + 1 ] {r}_{2}^{*} [ 2 n + 1 ] ) = \frac{1}{{γ}_{p}} {\hat{h}}_{2}^{H} {\hat{h}}_{2} + 2 {σ}_{{η}_{2}}^{1} \\ {C}_{12} = E ( {r}_{1} [ 2 n ] {r}_{2}^{*} [ 2 n ] ) + E ( {r}_{1} [ 2 n + 1 ] {r}_{2}^{*} [ 2 n + 1 ] ) = \frac{1}{{γ}_{p}} {\hat{h}}_{2}^{H} {\hat{h}}_{1} . \qquad [ 9 ]$$

Re-arranging terms of equation [9] shows that the pilot power to the total transmitted signal power ratio (Ec/Ior or γ_{P}) and noise variances \hat{σ}_{η}² can be estimated as:

$${\hat{γ}}_{p} = \frac{{\hat{h}}_{2}^{H} {\hat{h}}_{1}}{{C}_{12}} \\ {\hat{σ}}_{{η}_{1}}^{2} = \frac{1}{2} ( {C}_{11} - {C}_{12} \frac{{\hat{h}}_{1}^{H} {\hat{h}}_{1}}{{\hat{h}}_{2}^{H} {\hat{h}}_{1}} ) \\ {\hat{σ}}_{{η}_{2}}^{2} = \frac{1}{2} ( {C}_{22} - {C}_{12} \frac{{\hat{h}}_{2}^{H} {\hat{h}}_{2}}{{\hat{h}}_{2}^{H} {\hat{h}}_{1}} ) . \qquad [ 10 ]$$

However, in practice the receiver has only the estimates of C_{i,j},i, j=1,2, for example, Ĉ_{i,j}. Further, due to the constraints of the pilot power to the total transmitted signal power ratio Ec/Ior and noise variances, the pilot power ratio Ec/Ior and noise variances can be estimated as follows:

$${\hat{γ}}_{p} = arg {min}_{0 < {γ}_{p} \leq 1} {\vert {γ}_{p} {\hat{C}}_{12} - {\hat{h}}_{2}^{H} {\hat{h}}_{1} \vert}^{2} \\ {\hat{σ}}_{{η}_{1}}^{2} = max \{ {k}_{+} , \frac{1}{2} ( {\hat{C}}_{11} - \frac{{‖ {\hat{h}}_{1} ‖}^{2}}{{\hat{γ}}_{p}} ) \} \\ {\hat{σ}}_{{η}_{2}}^{2} = max \{ {k}_{+} , \frac{1}{2} ( {\hat{C}}_{22} - \frac{{‖ {\hat{h}}_{2} ‖}^{2}}{{\hat{γ}}_{p}} ) \} , \qquad [ 10 \text{-} a ]$$

where k₊ stands for the minimum of the noise variance in the system. This minimum may be set as a design factor in a practical receiver, and in the simulations detailed below it is set to 0.1.

With the knowledge of the pilot power ratio Ec/Ior and noise variance estimates, the LMMSE solution is derived similar to equation [7]. Without loss of generality, we proceed further by assuming \hat{σ}_{η}_{₁}²<\hat{σ}_{η}_{₂}². To employ the similar approach as in equation [7], the received signal at the second branch is scaled by the factor of

$$\sqrt{\frac{{\hat{σ}}_{{η}_{1}}^{2}}{{\hat{σ}}_{{η}_{2}}^{2}}} .$$

The computations then are:

$$\begin{matrix}{\tilde{r}}_{2} [ n ] = \sqrt{\frac{{\hat{σ}}_{{η}_{1}}^{2}}{{\hat{σ}}_{{η}_{2}}^{2}} {r}_{2} [ n ]} \\ = \frac{1}{{γ}_{P}} ( \sqrt{\frac{{\hat{σ}}_{{η}_{1}}^{2}}{{\hat{σ}}_{{η}_{2}}^{2}}} {\hat{H}}_{2} ) s [ n ] + \sqrt{\frac{{\hat{σ}}_{{η}_{1}}^{2}}{{\hat{σ}}_{{η}_{2}}^{2}}} {η}_{2} [ n ] \\ = \frac{1}{{γ}_{P}} {\tilde{\hat{H}}}_{2} s [ n ] + {\tilde{η}}_{2} [ n ] ,\end{matrix} \\ \tilde{r} [ n ] = ( \begin{matrix}{r}_{1} [ n ] \\ {\tilde{r}}_{2} [ n ]\end{matrix} ) , \\ \tilde{\hat{H}} = ( \begin{matrix}{\tilde{\hat{H}}}_{1} \\ {\tilde{\hat{H}}}_{2}\end{matrix} ) , \\ \tilde{η} [ n ] = ( \frac{{η}_{1} [ n ]}{{\tilde{η}}_{2} [ n ]} ) , . \qquad [ 11 ]$$

It is clear that

$$\tilde{η} [ n ] ∼ CN ( {0}_{2 F} , {\hat{σ}}_{{η}_{i 1}}^{2} {I}_{2 F} ) .$$

The LMMSE estimate of s[n−D] from the observation vector \tilde{r}[n] then becomes:

$$\hat{s} [ n - D ] = {\tilde{w}}_{LMMSE}^{H} \cdot \tilde{r} [ n ] , \\ {w}_{LMMSE} = {( \frac{1}{{\hat{γ}}_{p}} \tilde{\hat{H}} {\tilde{\hat{H}}}^{H} + {\hat{σ}}_{{η}_{1}}^{2} {I}_{2 F} )}^{- 1} \tilde{\hat{H}} {δ}_{D} \\ ∝ {\tilde{\hat{H}} ( {\tilde{\hat{H}}}^{H} \tilde{\hat{H}} + {\hat{γ}}_{p} {\hat{σ}}_{{η}_{1}}^{2} {I}_{\frac{F + L}{2} - 1} )}^{- 1} {δ}_{D} \\ = {\tilde{\hat{H}} ( {\tilde{\hat{H}}}_{1}^{H} {\tilde{\hat{H}}}_{1} + {\tilde{\hat{H}}}_{1}^{H} {\tilde{\hat{H}}}_{2} {\hat{γ}}_{p} {\hat{σ}}_{{η}_{1}}^{2} {I}_{\frac{F + L}{2} - 1} )}^{- 1} {δ}_{D} . \qquad [ 12 ]$$

Using the terms of equation [12], equation [7] is then changed to

$${\tilde{w}}_{1 , LMMSE} = {{\hat{H}}_{1} ( {\hat{H}}_{1}^{H} {\hat{H}}_{1} + {\tilde{\hat{H}}}_{2}^{H} {\tilde{\hat{H}}}_{2} + κ \cdot {I}_{\frac{F + L}{2} - 1} )}^{- 1} {δ}_{D} \\ {\tilde{w}}_{2 , LMMSE} = {{\tilde{\hat{H}}}_{2} ( {\hat{H}}_{1}^{H} {\hat{H}}_{1} + {\tilde{\hat{H}}}_{2}^{H} {\tilde{\hat{H}}}_{2} + κ \cdot {I}_{\frac{F + L}{2} - 1} )}^{- 1} {δ}_{D} , \qquad [ 13 ]$$

where κ=\hat{γ}_{P}\hat{σ}_{η}_{₁}².

Then ŝ[n−D] in eq. [8] becomes:

ŝ[n−D]=\tilde{w}_{1,LMMSE}^{H}·r₁[n]+ w̅_{2,LMMSE}^{H}·\tilde{r}₂[n]. [14]

It should be pointed out that the example detailed above can be extended to the case where more than 2 receive antennas are used in the user equipment (UE). If a higher computation complexity is allowed in the UE, for instance, the UE is able to estimate the covariance matrix of the receive signals from two receiver antennas, that is, the autocorrelation and cross-correlation functions of the received signals are available in the UE. The pilot Ec/Ior and noise variances can be estimated according to known methods or methods yet to be developed.

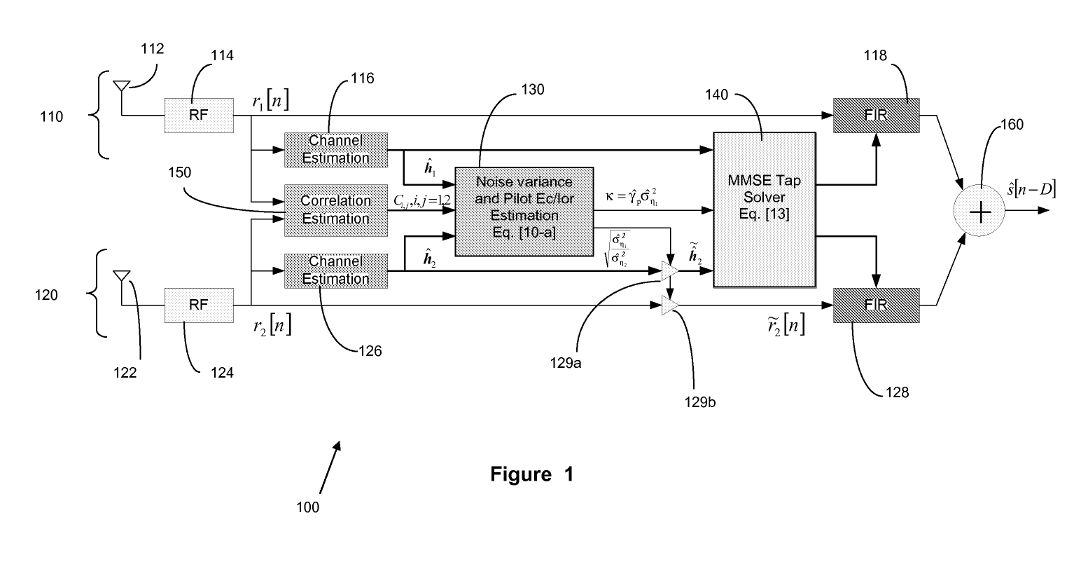

FIG. 1 shows an exemplary embodiment of a diversity receiver 100, which in an exemplary embodiment is a type 3 receiver. A wireless signal r(n) is received as a first diversity signal on a first (i^{th}) diversity branch 110 having a first diversity antenna 112 and first branch receiver front end 114 [e.g., amplifier, demodulator, sampler, etc. to take the first diversity signal to baseband, which baseband first diversity signal is represented as r₁(n)]. The wireless signal r(n) is also received as a second diversity signal on a second (j^{th}) diversity branch 120 having a second receive antenna 122 and second branch receiver front end 124 [e.g., similar amplifier, demodulator, sampler, etc. to take the second diversity signal to baseband, which baseband second diversity signal is represented as r₂(n)].

Along the first diversity branch 110 an estimate of the channel impulse response (CIR) ĥ₁ of the channel over which a first pilot signal was received (which is the same channel over which the baseband first diversity signal r₁(n) was received) is estimated at a first channel estimation block 116. This first-branch CIR estimate ĥ₁ is then output to both a noise variance and pilot power ratio block 130, and to a tap solver block 140.

In one implementation specific to the HSDPA system, the pilot signals are received on the CPICH which is transmitted from the transmitter's antenna. In current specifications for HSDPA, the CPICH is transmitted at the same time as other data channels that are processed on the diversity branches, but the CPICH uses a different spreading code than the data channels. The CPICH is therefore considered a superimposed training sequence, and so is considered herein as the ‘same’ channel as the data. At the receiver, both branches use the CPICH to correlate the respective received signal to obtain the CIR estimate. It is noted that this correlation based CIR estimation method is also typical in downlink for the WCDMA system where the superimposed training signal is used. Other systems which use time multiplexed training signal, for example GSM (global system for mobile communications), CDMA2000 (code division multiple access 2000) and TD-SCDMA (time division-synchronous code division multiple access), would typically employ a more complex method such as for example a least squares algorithm to find the CIR estimate.

Along the second diversity branch 120 an estimate of the channel impulse response (CIR) ĥ₂ of the channel over which a second pilot signal was received (which is the same channel over which the baseband second diversity signal r₂(n) was received) is estimated at a second channel estimation block 126. The second CIR ĥ₂ is output to both the noise variance and pilot power ratio block 130 and towards the tap solver block 140. In an exemplary embodiment there is only one channel estimation block doing both estimations. FIG. 1 illustrates a parallel implementation 116, 126 to better keep up with real time processing in demanding high-throughput environments.

Also, from the baseband first diversity signal r₁(n) and second diversity signal r₂(n) there is computed at a correlation estimator 150 correlation coefficients C_{i,j}, which is an estimate from the baseband signals on the i^{th} (first) and j^{th} (second) diversity branches. Equation [9] above is one way in which the correlation estimator may compute the correlation coefficients C₁₂, C₁₁ and C₂₂. These are also input to the noise variance and pilot power ratio block 130.

The noise variance and pilot power ratio block then has three separate inputs: the three correlation coefficients from the correlation estimation block; the first channel impulse response ĥ₁; and the second channel impulse response (CIR) ĥ₂. From these are computed the three values shown at equation [10-a]: the estimated pilot channel power to total transmitted signal power ratio \hat{γ}_{P}; the noise variance \hat{σ}_{η}_{₁}² for the signal received on the first diversity branch 110; and the noise variance \hat{σ}_{η}_{₂}² for the signal received on the second diversity branch 120. The minimum noise variance k₊ in the system may be retrieved from a local memory, for example after being hard-coded or signaled from the network.

From these three results the noise variance and pilot power ratio estimator block 130 outputs two values: the power adjusted noise (diagonal loading factor) κ=\hat{γ}ₚ\hat{σ}_{η}_{₁}² for the first diversity branch 110 which is output to the tap solver block 140; and the noise variance scaling factor

$$\sqrt{\frac{{\hat{σ}}_{{η}_{1}}^{2}}{{\hat{σ}}_{{η}_{2}}^{2}}}$$

for the second diversity branch 120. The noise variance scaling factor

$$\sqrt{\frac{{\hat{σ}}_{{η}_{1}}^{2}}{{\hat{σ}}_{{η}_{2}}^{2}}}$$

is used to scale the second channel impulse response ĥ₂ at a first multiplier 129a; and to scale the baseband second diversity signal r₂(n) at a second multiplier 129b.

Then the outputs of the tap solver block 140, which may be computed according to equation [13] above, are used to set the filter coefficients of a first finite impulse response (FIR) filter 118 along the first diversity branch 110, and to set the filter coefficients of a second finite impulse response (FIR) filter 128 along the first diversity branch 110. The filtered baseband signals diversity signals r₁(n) and r₂(n) are finally combined at a combiner 160 so as to finally output the estimate for the D th delayed transmitted composite chip ŝ[n−D] according to equation [14] above.

The noise variance and pilot power ratio estimation block 130 provides the proper scaling factor

$$\sqrt{\frac{{\hat{σ}}_{{η}_{1}}^{2}}{{\hat{σ}}_{{η}_{2}}^{2}}}$$

for the CIR estimate and for the received signal corresponding to the second receive branch, as well as the diagonal loading factor κ=\hat{γ}ₚ\hat{σ}_{η}_{₁}² for the tap solver. As shown in equation [10], this approach only requires calculating the auto-correlation C₁₁, C₂₂ and cross-correlation C₁₂ coefficients of the received signals based on the estimated CIRs. It should be noted that the correlation estimation block 150 in FIG. 1 estimates the correlation coefficients using the received signals, which in some exemplary embodiments may have a somewhat higher complexity than prior art approaches to receive diversity. The signal processing technique detailed herein can be implemented in different embodiments as hardware, as software, or as a combination of hardware and software.

The technique outlined with respect to FIG. 1 extends the tap solver to cope with the case of different signal to noise ratios on the different diversity branches, unlike the prior art summarized above in which the typical type 3 receiver assumes the same noise variance for them. The added complexity at the receiver for the noise variance and pilot Ec/Ior estimation is seen to be modest and well worth the benefit.

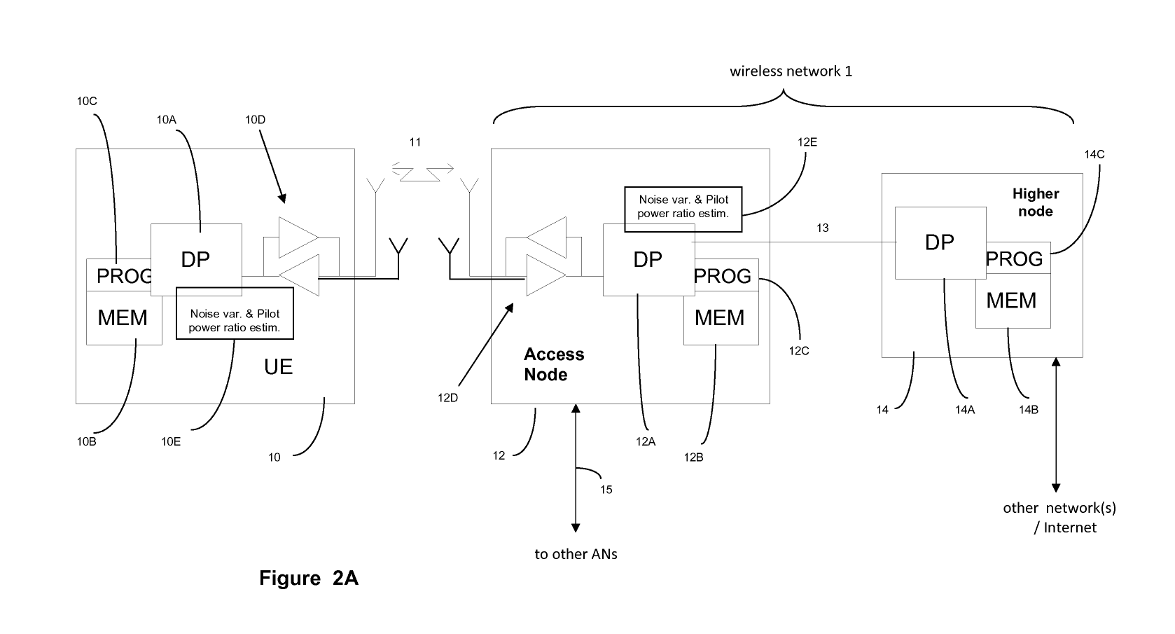

Now is detailed an exemplary environment for the exemplary embodiment of FIG. 1 and for other embodiments of the invention. Reference is made to FIG. 2A for illustrating a simplified block diagram of various electronic devices and apparatus that are suitable for use in practicing the exemplary embodiments of this invention. In FIG. 2A a wireless network 1 is adapted for communication over a wireless link 11 with an apparatus, such as a mobile communication device which may be referred to as a UE 10, via a network access node 12, such as a base station (e.g., Node B or e-Node B). The network 1 may include a higher node 14 which is a controller of a radio network, known in various systems as a radio network controller RNC, network control element (NCE), mobility management entity (MME) or serving gateway (SGW). By whatever name, the higher node 14 provides connectivity between the wireless network 1 and further networks, such as a publicly switched telephone network and/or a data communications network (e.g., the internet).

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the access node 12 via one or more antennas (112, 122 in FIG. 1; or 36 in FIG. 2B). The access node 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The access node 12 is coupled via a data/control path 13 to the higher node 14. The access node 12 may also be coupled to another access node via a data/control path 15, or in other systems all communications between adjacent access nodes may run through the higher node 14.

Similarly, the higher node 14 includes a controller, such as a computer or a data processor (DP) 14A, a computer-readable memory medium embodied as a memory (MEM) 14B that stores a program of computer instructions (PROG) 14C, and a modem (not shown) for communication with the access node 12 over the data/control path 13. The higher node 14 may also interface the access node to other networks such as for example a publicly switched telephone network or the Internet.

While the exemplary embodiment of FIG. 1 was detailed with respect to the UE, the access node 12 also has a receiver and can implement these teachings for processing received signals on diversity branches, such as was detailed at FIG. 1 for example. For software implementations of the invention, at least one of the PROGs 10C and 12C is assumed to include program instructions that, when executed by the associated DP, enable the device to operate in accordance with the exemplary embodiments of the invention. That is, the exemplary embodiments of this invention may be implemented at least in part by computer software executable by the DP 10A of the UE 10 and/or by the DP 12A of the eNB 12, or by hardware, or by a combination of software and hardware (and firmware).

According to an exemplary embodiment of the invention the UE 10 may be assumed to also include a noise variance and pilot SNR estimation block 10E, and the access node 12 may include a noise variance and pilot SNR estimation block 12E. Each of these is functionally similar to the similar block 130 detailed with respect to FIG. 1.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 2B illustrates further detail of an exemplary UE in both plan view (left) and sectional view (right), and the invention may be embodied in one or some combination of those more function-specific components. At FIG. 2B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 2B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio (BT) 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or in access node 12, may operate in a slave relationship to the main processor 10A, 12A, which may then be in a master relationship to them. In an exemplary embodiment the noise variance and pilot power ratio block 130 (also shown as 10E for the UE and 12E for the access node) is embodied within the baseband chip 42, though it is noted that other embodiments need not be disposed there but may be disposed across various chips and memories as shown or disposed within another processor that combines some of the functions described above for FIG. 2B. Any or all of these various processors of FIG. 2B access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 2B.

Note that the various chips (e.g., 38, 40, 42, etc.) that were described above may be combined into a fewer number than described and, in a most compact case, may all be embodied physically within a single chip.

Specific embodiments of the access node 12 may reflect in part the various chips and memories shown at FIG. 2B for the UE 10.

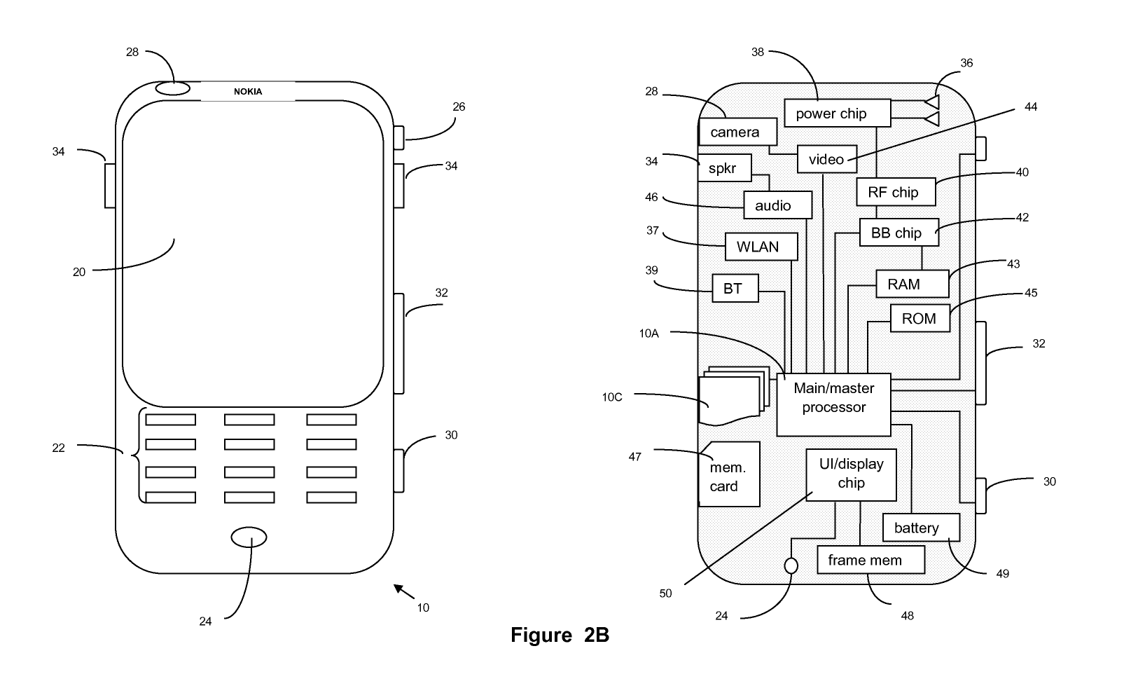

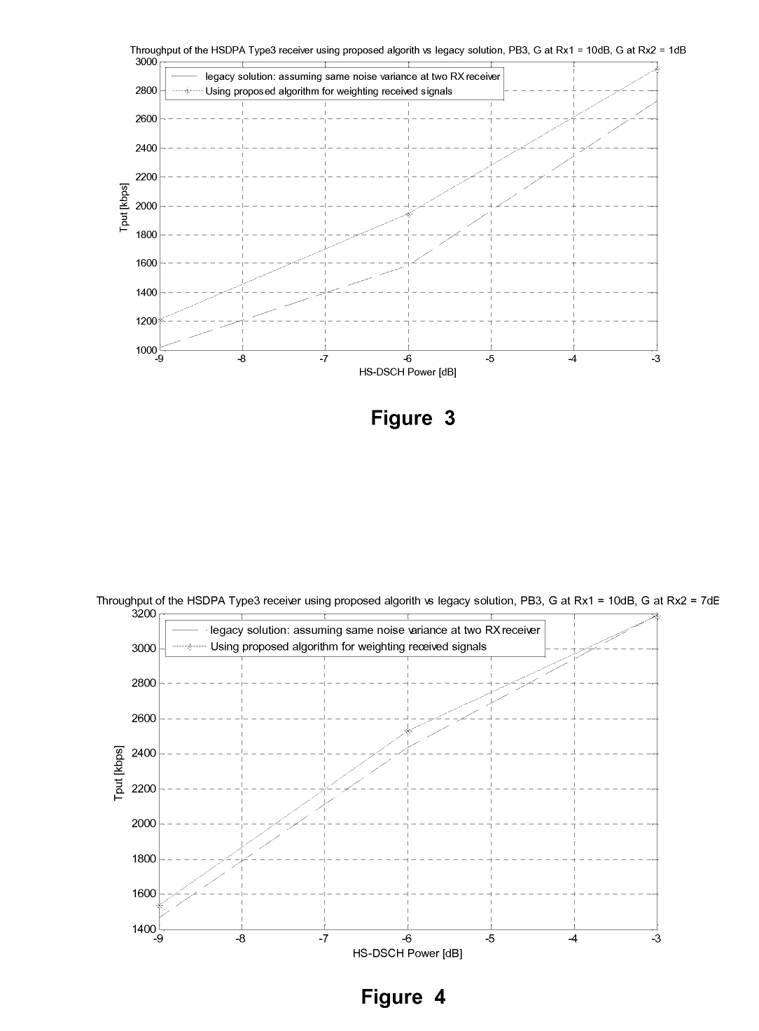

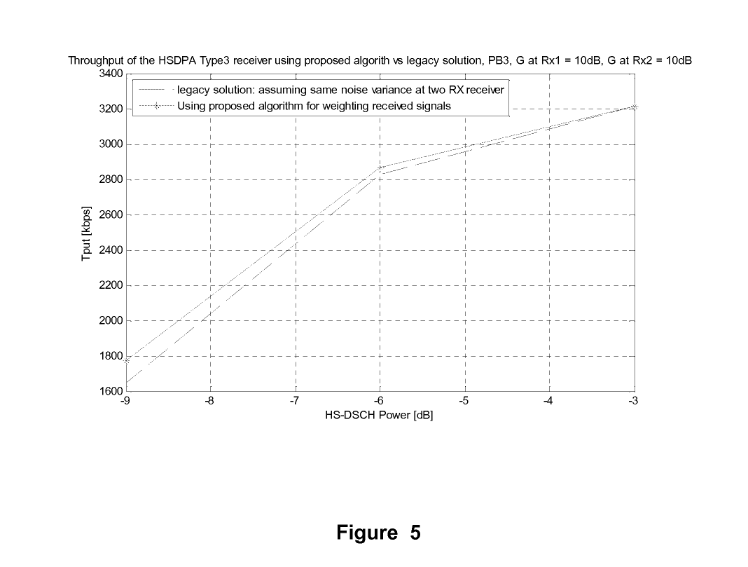

The specific exemplary embodiment of FIG. 1 was tested via simulation against the prior art type 3 receiver which assumes the same signal to noise ratio (SNR) on both diversity branches. Results of those simulations are shown at FIGS. 3-5 for PB3, which is the ITU (International Telecommunications Union) Pedestrian B channel with mobile speed of 3 km/hr (see table B.1B at page 149 of 3GPP TS 25.101 v8.2.0). Specifically, FIG. 3 compares throughput of a HSDPA type 3 receiver using the arrangement of FIG. 1 against a similar HSDPA type 3 receiver which processes the diversity branches under the assumption of the same SNR, with a 10—dB gain on the first diversity receive branch and a 1 dB gain on the second diversity receive branch. FIG. 4 is similar but where the gain on the second diversity branch is 7 dB; and FIG. 5 charts throughput data for the condition that both branches have the same 10 dB gain. Whereas the technique described herein is shown by FIGS. 3-5 to increase throughput (as compared to the case where the same SNR is assumed) under each of those plotted conditions, it can be seen that greater throughput improvement is achieved for greater differences in gain among the two diversity signals. It is noted that these simulation results are for the gains stipulated and for the specific embodiment of FIG. 1 compared to a conventional type 3 diversity receiver set forth at 3GPP TS25.101; other embodiments and other gain factors may show different results.

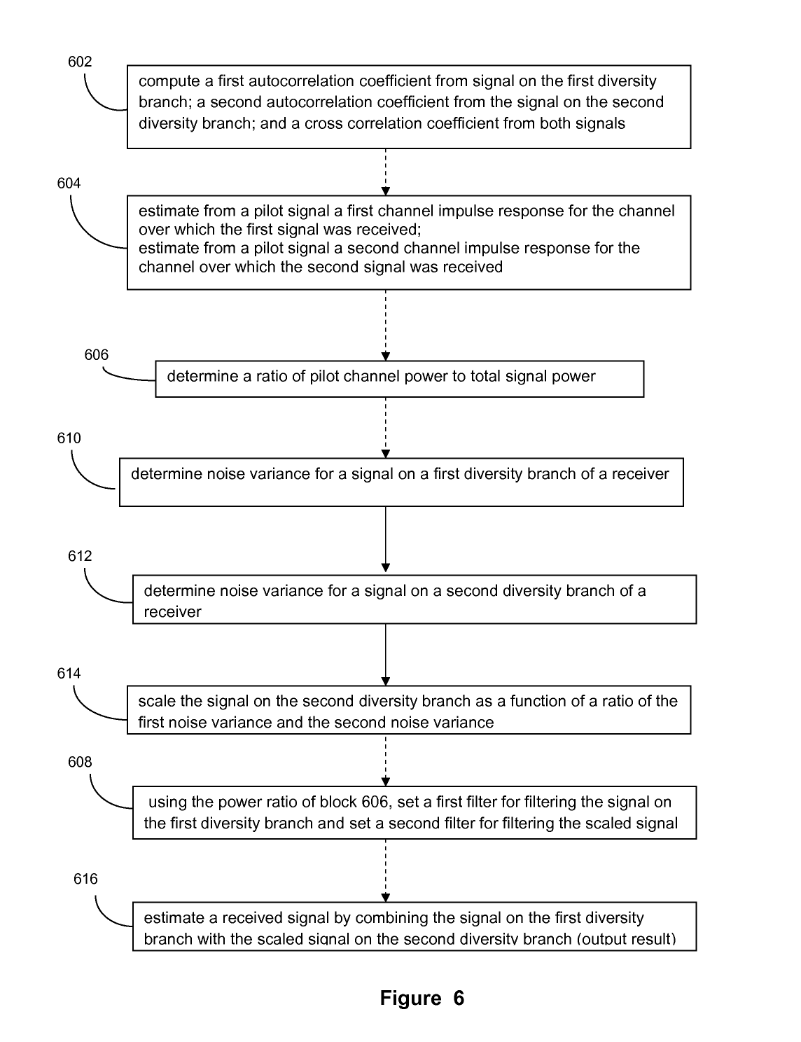

Based on the foregoing it should be apparent that the exemplary embodiments of this invention provide a method, apparatus and a memory storing a computer program(s) that when executed by a processor result in actions which are detailed at FIG. 6, which is a logic flow diagram. In accordance with an exemplary embodiment of the invention, those actions (or method steps or functions performed by hardware) comprise: determining noise variance for a signal on a first diversity branch of a receiver (block 610); determining noise variance for a signal on a second diversity branch of a receiver (block 612); scaling the signal on the second diversity branch as a function of a ratio of the first noise variance and the second noise variance (block 614); and estimating a received signal by combining the signal on the first diversity branch with the scaled signal on the second diversity branch (block 616, which may also include outputting the estimated received signal).

In accordance with more specific implementations, a first autocorrelation coefficient is computed from the signal on the first diversity branch and a second autocorrelation coefficient is computed from the signal on the second diversity branch and a cross correlation coefficient is computed from both of those signals (block 602). These three correlation coefficients are then used to determine the two noise variances of the above paragraph.

In accordance with another specific implementation which may further be combined with the correlation coefficient aspect, a first channel impulse response for the channel over which the first signal was received is estimated from a pilot signal, and a second channel impulse response for the channel over which the second signal was received is estimated from a pilot signal (block 604). The noise variances are determined using these channel impulse response estimates.

In accordance with another specific implementation which may further be combined with the channel impulse response aspect (and also with the correlation coefficient aspect), there is also determined a ratio of pilot channel power to total signal power (block 606), where the pilot channel power is for the channel over which the pilot signals were received and total signal power is for the signal being estimated. In an embodiment, that power ratio is used to set coefficients for a first filter for filtering the signal on the first diversity branch and to set coefficients for a second filter for filtering the scaled signal on the second diversity branch (block 608) before they are combined into the estimated signal.

In a specific exemplary embodiment of the invention as apparatus, such an apparatus includes first determining means for determining noise variance for a signal on a first diversity branch (e.g. the noise variance estimation function at block 130 of FIG. 1); second determining means for determining noise variance for a signal on a second diversity branch of a receiver (e.g. the same noise variance estimation function at block 130 of FIG. 1); scaling means for scaling the signal on the second diversity branch as a function of a ratio of the first noise variance and the second noise variance (e.g., the second multiplier 129b at FIG. 1); and estimating means for estimating a received signal by combining the signal on the first diversity branch with the scaled signal on the second diversity branch (e.g., the combiner 160 at FIG. 1).

The various blocks shown in FIG. 6 may be viewed as method steps, and/or as operations that result from operation of computer program code, and/or as a plurality of coupled logic circuit elements constructed to carry out the associated function(s). As noted above for the case where these teachings are applied to more than two diversity branches in a receiver, the extension of FIG. 6 is straightforward as detailed above for the example of a three diversity branch receiver.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the HSDPA system, it should be appreciated that the exemplary embodiments of this invention are not limited for use with only this one particular type of wireless communication system, and that they may be used to advantage in other wireless communication systems such as for example UTRAN (universal mobile telecommunications system terrestrial radio access network), E-UTRAN (evolved UTRAN or long term evolution LTE of UTRAN), WCDMA (wideband code division multiple access), WLAN (wireless local area network), GSM (global system for mobile communications), and others.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the formulas and expressions that use these various parameters may differ from those expressly disclosed herein. Further, the various names assigned to different channels (e.g., CPICH) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1.-27. (canceled)

28. A method comprising:
determining a first noise variance for a signal received on a first diversity branch;
determining a second noise variance for a signal received on a second diversity branch;
scaling the signal received on the second diversity branch as a function of a ratio of the first noise variance and the second noise variance; and
estimating a received signal by combining the signal on the first diversity branch with the scaled signal on the second diversity branch.

29. The method according to claim 28, in which estimating the received signal comprises outputting the estimated received signal from a type 3 receiver, and the method is performed by a user equipment operating in a high speed downlink packet access system.

30. The method according to claim 28, further comprising computing a first autocorrelation coefficient from the signal on the first diversity branch, and computing a second autocorrelation coefficient from the signal on the second diversity branch, and computing a cross correlation coefficient from the signals on the first and second diversity branches; and wherein each of the first and the second noise variances are determined using the first and second autocorrelation coefficients and the cross correlation coefficient.

31. The method according to claim 28, further comprising:
estimating from at least one pilot signal a first channel impulse response for a channel over which the signal was received on the first diversity branch; and
estimating from the at least one pilot signal a second channel impulse response for a channel over which the signal was received on the second diversity branch.

32. The method according to claim 31, in which:
the first noise variance is determined using the estimated first channel impulse response for the first channel; and
the second noise variance is determined using the estimated second channel impulse response for the second channel.

33. The method according to claim 32, further comprising:
determining a ratio of pilot channel power to total signal power, in which the pilot channel power is for the channel over which the at least one pilot signal was received and total signal power is for the received signal which is estimated by the combining.

34. The method according to claim 33, further comprising, prior to combining the signal on the first diversity branch with the scaled signal on the second diversity branch:
using the determined ratio to set coefficients for a first filter and filtering the signal that is received on the first diversity branch with the first filter; and
using the determined ratio to set coefficients for a second filter and filtering the signal that is received on the second diversity branch after scaling.

35. A memory storing a program of computer readable instructions that when executed by at least one processor result in actions comprising:
determining a first noise variance for a signal received on a first diversity branch of a receiver;
determining a second noise variance for a signal received on a second diversity branch of the receiver;
scaling the signal received on the second diversity branch as a function of a ratio of the first noise variance and the second noise variance; and
estimating a received signal by combining the signal on the first diversity branch with the scaled signal on the second diversity branch.

36. The memory according to claim 35, the actions further comprising computing a first autocorrelation coefficient from the signal on the first diversity branch, and computing a second autocorrelation coefficient from the signal on the second diversity branch, and computing a cross correlation coefficient from the signals on the first and second diversity branches; and wherein each of the first and the second noise variances are determined using the first and second autocorrelation coefficients and the cross correlation coefficient.

37. The memory according to claim 35, the actions further comprising:
estimating from at least one pilot signal a first channel impulse response for a channel over which the signal was received on the first diversity branch; and
estimating from the at least one pilot signal a second channel impulse response for a channel over which the signal was received on the second diversity branch.

38. The memory according to claim 37, in which:
the first noise variance is determined using the estimated first channel impulse response for the first channel; and
the second noise variance is determined using the estimated second channel impulse response for the second channel.

39. The memory according to claim 38, the actions further comprising:
determining a ratio of pilot channel power to total signal power, in which the pilot channel power is for the channel over which the at least one pilot signal was received and total signal power is for the received signal which is estimated by the combining.

40. The memory according to claim 39, the actions further comprising, prior to combining the signal on the first diversity branch with the scaled signal on the second diversity branch:
using the determined ratio to set coefficients for a first filter and filtering the signal that is received on the first diversity branch with the first filter; and
using the determined ratio to set coefficients for a second filter and filtering the signal that is received on the second diversity branch after scaling.

41. An apparatus comprising at least one processor and at least one memory including computer readable instructions, the at least one memory and the computer readable instructions configured to, with the at least one processor, cause the apparatus to:
determine a first noise variance for a signal received on a first diversity branch of the apparatus;
determine a second noise variance for a signal received on a second diversity branch of the apparatus;
scale the signal received on the second diversity branch as a function of a ratio of the first noise variance and the second noise variance; and
estimate a received signal by combining the signal on the first diversity branch with the scaled signal on the second diversity branch.

42. The apparatus according to claim 41, wherein the at least one memory and the computer readable instructions are further configured to, with the at least one processor, cause the apparatus to output the estimated received signal from a type 3 receiver of the apparatus, and the apparatus comprises a user equipment operating in a high speed downlink packet access system.

43. The apparatus according to claim 41, wherein the at least one memory and the computer readable instructions are further configured to, with the at least one processor, cause the apparatus to:
compute a first autocorrelation coefficient from the signal on the first diversity branch, and to compute a second autocorrelation coefficient from the signal on the second diversity branch, and to compute a cross correlation coefficient from the signals on the first and second diversity branches;
and determine each of the first and the second noise variances using the first and second autocorrelation coefficients and the cross correlation coefficient.

44. The apparatus according to claim 41, wherein the at least one memory and the computer readable instructions are further configured to, with the at least one processor, cause the apparatus to:
estimate from at least one pilot signal a first channel impulse response for a channel over which the signal was received on the first diversity branch; and
estimate from the at least one pilot signal a second channel impulse response for a channel over which the signal was received on the second diversity branch.

45. The apparatus according to claim 44, wherein the at least one memory and the computer readable instructions are further configured to, with the at least one processor, cause the apparatus to:
determine the first noise variance using the estimated first channel impulse response for the first channel; and
determine the second noise variance using the estimated second channel impulse response for the second channel.

46. The apparatus according to claim 45, the wherein the at least one memory and the computer readable instructions are further configured to, with the at least one processor, cause the apparatus to determine a ratio of pilot channel power to total signal power, wherein the pilot channel power is for the channel over which the at least one pilot signal was received and total signal power is for the received signal which is estimated by the combining.

47. The apparatus according to claim 46, wherein the at least one memory and the computer readable instructions are further configured to, with the at least one processor, cause the apparatus prior to combining the signal on the first diversity branch with the scaled signal on the second diversity branch, to:
use the determined ratio to set coefficients for a first filter and to filter the signal that is received on the first diversity branch with the first filter; and
use the determined ratio to set coefficients for a second filter and to filter the signal that is received on the second diversity branch after scaling.
